(19) United States
(12) Patent Application Publication
(10) Pub. No.: US 2015/0197627 A1
(43) Pub. Date: Jul. 16, 2015

(54) FORMULATIONS OF THIN FILMS

(71) Applicant: Foodhandler, Inc., Reno, NV (US)

(72) Inventor: Jian Tao, Reno, NV (US)

(21) Appl. No.: 14/596,890

(22) Filed: Jan. 14, 2015

Related U.S. Application Data
(60) Provisional application No. 61/927,686, filed on Jan. 15, 2014.
(60) Provisional application No. 61/927,697, filed on Jan. 15, 2014.

(51) Int. Cl. C08L 23/06; A41D 19/015; A41D 19/00

(52) U.S. Cl. CPC C08L 23/06; A41D 19/0006; A41D 19/015

(57) ABSTRACT

New formulations and attributes of thin polyethylene-based films are provided which may be used for gloves, aprons, trash bags and the like. Gloves could be made from primarily high and low density polyethylene (HDPE, LDPE, LLDPE, m-LLDPE, etc.). An elastomer including but not limiting to polypropylene based elastomer (PBE), ethylene-propylene copolymer (EPC), ethylene vinyl acetate (EVA), ethylene methyl acetate (EMA), ethylene butyl acetate (EBA), styrene-butadiene-styrene (SBS), styrene-isoprene-styrene (SIS), and styrene-ethylene-butadiene-styrene (SEBS) etc. may be utilized as a modifier.

### CROSS REFERENCE

This application claims priority to U.S. Provisional Application Ser. No. 61/927,686, filed Jan. 15, 2014, and to U.S. Provisional Application Ser. No. 61/927,697, filed Jan. 15, 2014, both of which are hereby incorporated by reference.

### FIELD OF THE INVENTION

The present invention relates to formulations for producing casting or blowing films. The films may be further converted into a wide range of polyethylene based articles such as food service gloves, aprons, food storage bags, trash can liners, and the like with improved strength and durability even at reduced thickness.

### BACKGROUND OF THE INVENTION

Traditionally, single use disposable gloves have been produced for utilization in, but not limited to medical procedures as well as for use in the food service industry. These types of single use gloves are employed to protect both the user as well as other individuals from contact with various germs or pathogens. Generally, these types of single use disposable gloves are manufactured using a dipping method or a cutting and heat sealing method. With the cutting and heat sealing method, two films would be laid upon each other on a flat surface. If a glove is to be produced, a metallic hand shaped knife constructed from, but not limited to, copper or stainless steel would be applied to the top of the first film to cut through both film layers. Since the hand shaped knife is also heated, the layers would be welded together along the cutting line as the films are cut to form one glove. The typical polyethylene based films for gloves, bags, aprons, and the like are largely made via one of two primary processes: blowing or casting. Both processes can yield similar films in many cases; however, in certain cases, the resulting films may have distinctively different characteristics.

For instance, casting films are mostly produced via down flow water cooling, whereas blowing films can be produced either via up blown air cooling or down blown water cooling, depending on the different materials used. For polyethylene based formulations, up blown air cooling is more common. As the result, blowing films are usually thinner: 0.006 mm is not uncommon, whereas casting films are usually thicker than 0.02 mm.

Recently, U.S. Pat. No. 8,572,765 disclosed gloves made from elastic films using polypropylene based elastomer (PBE), ethylene-propylene copolymer (EPC), ethylene vinyl acetate (EVA), ethylene methyl acetate (EMA), ethylene butyl acetate (EBA), and styrene-butadiene-styrene (SBS), etc. These elastic films are usually thicker, 0.03˜0.06 mm, in contrast to traditional polyethylene films.

During the blowing process, when the tube collapses at the top of air bulb, the film is still pretty warm. Therefore usually, the texture obtained via this process cannot be particularly aggressive. Otherwise, the collapsed tube might not be easy to separate for further processing. In contrast to blowing, water cooled casting film are a single layer at lower temperatures, and it is therefore easy to form an aggressive texture without impacting of further processing.

For easily crystallized polyethylene plastic (and especially high density polyethylene), immediate water cooling is more likely to yield films with high clarity whereas slow air cooling is more likely to yield opaque film.

Additionally, gloves traditionally made from polyethylene via a cutting and sealing process were mainly used by the food service industry. In comparison to medical gloves made from natural rubber latex via a dipping process, polyethylene gloves are not as formfitting. The most noticeable reason is the material difference: the plastic films are not as elastic as rubbery films As the result, the formers of such plastic gloves were not designed to create formfitting gloves.

### SUMMARY OF THE INVENTION

As mentioned above, polyethylene based casting films usually have a thickness more than 0.02 mm. In the past, with the materials used in this invention individually (i.e., a variety of polyethylene and polypropylene based elastomers), it is almost impossible to cast films with a thickness profile less than 0.02 mm without compromising film integrity significantly. However, combinations of these materials (according to the formulations disclosed herein—a blend of polyethylene and propylene based elastomers), films may be cast at thicknesses of about 0.01 mm˜0.02 mm without compromising film integrity. Further, in some cases, the film strength and durability can be improved. These combinations also allow increased inorganic filler loading limit without compromising film performance, while keeping the original thickness.

### DETAILED DESCRIPTIONS OF THE INVENTION

In contrast to U.S. Pat. No. 8,572,765, which utilized materials exhibiting certain elasticity (preferred to make formfitting gloves at a thickness rage 0.03˜0.06 mm, measured prior to texture), this invention includes the deployment of these elastomers as modifiers to the polyethylene based thin film articles. The below disclosed formulations showed the following advantages over regular polyethylene films:
improvement of the polyethylene melt strength made it possible to make thinner films previously unachievable; and
increasing the compatibility between polyethylene and inorganic fillers.
   In addition, the U.S. Pat. No. 8,572,765 relates to formulations for making films suitable for single use disposable food service gloves. This invention includes formulations for making films for broader applications: aprons, bags, can liners, etc., in addition to gloves.

### Preferred Embodiment 1: Casting Films Without Fillers

The casting films for gloves manufacturing usually have a thickness range of 0.02˜0.03 mm for several reasons. First, from an application point of view, the films need to be this thick in order to ensure the film's integrity and durability. If the film is too thin (e.g., thinner than 0.02 mm), the converted articles would not have sufficient mechanical strength. If the film is too thick (e.g., thicker than 0.03 mm), the converted articles are too stiff and clumsy. Secondly, from a film casting process point of view, the polyethylene melt strength does not allow the film thickness to be lower than 0.02 mm. It has been found that with a film thickness lower than 0.02 mm, neither polyethylene nor elastic materials yield a uniform thickness profile. In other words, an acceptably consistent film thickness can not be maintained. Eventually, the film will break down when the thickness fluctuations become out of control.

For aprons or can liners, the thickness could be well beyond 0.03 mm depending on applications. But again, it is impractical to make any articles with thickness thinner than 0.02 mm.

However, by utilizing the combination of polyethylene and elastic modifiers (one or blends and mixtures of: polypropylene based elastomer (PBE), ethylene-propylene copolymer (EPC), ethylene vinyl acetate (EVA), ethylene methyl acetate (EMA), ethylene butyl acetate (EBA), styrene-butadiene-styrene (SBS), styrene-isoprene-styrene (SIS), and styrene-ethylene-butadiene-styrene (SEBS) etc.) disclosed herein, the casting of thinner films at 0.015 mm is possible, and even castings as low as 0.01 mm are viable. These thickness parameters have never been achieved before, especially with a uniform thickness profile. Thus, thicknesses anywhere from 0.03 mm to 0.01 are achievable, and any thicknesses or ranges of thicknesses therebetween are viable (such as 0.02 mm to 0.01 mm)

TABLE I
Casting film thickness and strength

| Descriptions | Thickness (mm) | Film Making | Force @ Break (N) |
|---|---|---|---|
| Casting PE (PA) | 0.030 | Success | 3.8 |
| Casting PE (PA) | 0.025 | Success | 3.4 |
| Casting PE (PA) | 0.020 | Success | 3.0 |
| Casting PE (PA) | 0.018 | Failure | N/A |
| Formulation I | 0.025 | Success | 4.1 |
| Formulation I | 0.020 | Success | 3.6 |
| Formulation I | 0.018 | Success | 3.2 |
| Formulation I | 0.015 | Success | 3.0 |
| Formulation I | 0.010 | failure | N/A |
| Formulation II | 0.018 | Success | 3.7 |
| Formulation III | 0.025 | Success | 3.5 |
| Formulation III | 0.018 | Success | 3.0 |

In the above Table 1, the entries labeled “Casting PE” are “PA” or “Prior Art,” and are 100% polyethylene. Formulation I contains about 10% of polypropylene based elastomer (PBE) whereas Formulation II contains about 20% of PBE, with the balance of each being polyethylene. Formulation III contains about 10% of styrene-ethylene-butadiene-styrene (SEBS), with the balance being polyethylene. The thickness is measured without texture or embossing. The actual film thickness measured after embossing may vary significantly depending on the roughness or coarseness of the texture desired for certain applications.

There are a few observations we can draw from this table. First, as stated above for plain polyethylene films, it is impractical to cast films with good quality consistency if the thickness is below 0.02 mm. Control and stabilization of film thickness at 0.018 mm were not possible. Secondly, when elastic modifiers are used, control and stabilization of the film thickness at 0.018 mm and 0.015 mm were achievable. By reduced the thickness without compromising performance, cost saving are achieved in production, transportation and storage. Thirdly, at the same thickness as compared to 100% polyethylene, films with an elastic modifier have higher strength. Formulations I and III, at thicknesses of 0.025 mm, were stronger than 100% polyethylene film at 0.025 mm. Additionally, higher percentages of modifier (e.g., Formulation II compared to Formulation I) resulted in improved film strength at the same thickness. A glove made via the cutting and heat sealing method with such a formulation may have a weight of between 0.8 and 1.8 grams.

The above Formulations also showed improvements for film blowing processes. Normally, it is impractical to blow polyethylene films while maintaining consistent thickness profiles with thicknesses below 0.006 mm However, using Formulation I for example, films were blown anywhere from 0.015 mm down to as thin as 0.004 mm with acceptable quality consistency. Any desired thickness therebetween is therefore viable.

An additional benefit was found for films with a modifier Polyethylene is somewhat rigid even at low thickness ranges. The addition of an elastic modifier as discussed herein made the resulting films feels softer. This characteristic makes gloves softer and more formfitting. Trash can liners may also perform better in winter outdoor conditions.

In the glove manufacturing sector, film modulus is usually used to describe the softness/hardness of the films. A lower modulus means better elasticity. In a modulus calculation, film thickness is normalized to show material softness characteristics. Natural rubber latex is commonly known as the gold standard in terms of formfitting, whereas polyethylene is extremely un-formfitting due to its plastic nature. Herein, the disclosed formulations are blends of plastic polyethylene and elastomers. As anticipated, the modulus of disclosed formulations falling between natural rubber and polyethylene, as seen in Table II below:

TABLE II
Modulus of different materials

| | Modulus @ 100% | Modulus @ 300% |
|---|---|---|
| Descriptions | (MPa) | (MPa) |
| Casting PE | 3.5 | 4.0 |
| Formulation I | 3.0 | 3.5 |
| Natural rubber Latex | 1.1 | 2.2 |

As the result of this elasticity modification, the formers of the gloves have been redesigned to make gloves with improved formfitting characteristics. It has been found that a modulus as low as about 2.5-MPa at 300% may be achievable. It is noted that a modulus of 4.0 @ 300% is substantially the upper end of an acceptable range, as this is the modulus of casting polyethylene. Although these improved gloves may still not be as elastic as natural rubber latex in some cases, they represent a substantial improvement over regular polyethylene.

### Preferred Embodiment 2: Casting Films With Fillers

It is common to add inorganic fillers such as calcium carbonate, titanium dioxide, talc, diatomite earth, etc., into plastic films for various purposes: cost reduction, decreasing translucency, and so on. This is especially true for articles like aprons, which do not need heat sealing for further processing. However, for gloves or bags that needs heat sealing, it is normally preferred not to add inorganic fillers to regular polyethylene films due to the incompatibility between the plastic matrix and the inorganic filler.

U.S. Pat. No. 8,572,765 is one of a few publications which disclose film gloves with significant inorganic filler content. However, the polymeric matrix in U.S. Pat. No. 8,572,765 is not polyethylene. Rather, that patent discloses a matrix which is primarily ethylene-propylene copolymer (EPC) or polypropylene based elastomer (PBE). In contrast, a certain percentage of EPC or PBE may be used as modifier to the polyethylene matrix hereof. In doing so, inorganic fillers can be loaded into the polyethylene films disclosed herein for further heat sealing process.

Depending on the application, film thickness, calcium carbonate particle size, and size distribution, a polyethylene film may be loaded with up to 50% of calcium carbonate. However, practically, for thin film articles like aprons, the inorganic filler loading is usually less than 20%. Higher inorganic loading would weaken the film strength, and thus film integrity and durability. When the loading reaches 30˜40%, it was found that the film actually has no strength at all.

Elastic materials like polypropylene based elastomer (PBE), ethylene-propylene copolymer (EPC), ethylene vinyl acetate (EVA), ethylene methyl acetate (EMA), ethylene butyl acetate (EBA), styrene-butadiene-styrene (SBS), styrene-isoprene-styrene (SIS), and styrene-ethylene-butadiene-styrene (SEBS) etc. can usually load more inorganic fillers. In one embodiment hereof, inorganic fillers were successfully loaded up to 40%, and the films still showed good enough strength for intended applications: gloves, aprons, and bags.

TABLE III
Filler loading and strength

| Descriptions | CaCO₃ (%) | Film Making | Force @ Break (N) |
|---|---|---|---|
| Casting PE I | 0 | Success | 3.0 |
| Casting PE II | 10 | Success | 2.8 |
| Casting PE III | 20 | Success | 3.5 |
| Casting PE IV | 30 | Failure | N/A |
| Formulation IV | 20 | Success | 2.8 |
| Formulation V | 30 | Success | 2.5 |

In Table III, the film thickness was controlled at 0.020 mm for Casting PE I-IV (which are each simply pure polyethylene plus the shown amount of filler). As can be seen, at filler loads at 30%, the process was a failure. Formulation IV and V each contain 20% of PBE modifier plus the shown amount of filler, with the balance being polyethylene. The thickness for Formulations IV and V were controlled at 0.018 mm. As can be seen, even with a smaller thickness, a filler load of 30% was successfully achieved.

Although the present invention has been described with reference to a particular embodiment thereof, it will be understood by those skilled in the art that modifications may be made without departing from the scope of the invention. Accordingly, all modifications and equivalents which are properly within the scope of the appended claims are included in the present invention.

1. A formulation comprising:
about 60% to 99% polyethylene substrate;
about 1% to 40% elastomer as modifier to the polyethylene substrate.

2. The formulation of claim 1 wherein the elastomer is at least one of: polypropylene based elastomer (PBE), ethylene-propylene copolymer (EPC), ethylene vinyl acetate (EVA), ethylene methyl acetate (EMA), ethylene butyl acetate (EBA), styrene-butadiene-styrene (SBS), styrene-isoprene-styrene (SIS), and styrene-ethylene-butadiene-styrene (SEBS).

3. The formulation of claim 1 wherein the polyethylene is at least one of high and low density polyethylene (HDPE, LDPE, LLDPE, m-LLDPE).

4. The formulation of claim 1, wherein the elastomer is an ethylene-propylene copolymer.

5. The formulation of claim 1, wherein the formulation has a modulus at 300% in the range of between about 2.5-MPa and 4.0-MPa.

6. A planar film comprised of the formulation of claim 1, wherein the planar film is cast with thickness of about 0.01 to 0.03 mm without texture.

7. The planar film of claim 6 wherein the planar film is further cast with a thickness of between about 0.01 and 0.02 mm without texture.

8. A planar film comprised of the formulation of claim 1, wherein the planar film is blown to a thickness of about 0.004 to 0.015 mm without texture.

9. A planar film comprised of the formulation of claim 1, wherein the planar film is blown to a thickness at least as low as 0.004 mm.

10. A glove comprising:
at least one top layer in the form of a hand;
at least one bottom layer in the form of a hand, wherein at least one of said at least one top layer and said at least one bottom layer is composed of the film of claim 1;
wherein at least a portion of a periphery of said at least one bottom layer is sealed to a portion of a periphery of said at least one top layer to form the glove via a cutting and sealing process;
wherein an opening is provided between said at least one top layer and said at least one bottom layer for the insertion of a human hand therebetween.

11. The glove in accordance with claim 10, wherein said the weight of a said glove is between about 0.8 and 1.8 grams.

12. A formulation comprising:
about 50% to 99% polyethylene substrate;
about 1% to 40% elastomer as modifier to the polyethylene substrate; and
about 10% to 30% inorganic filler.

13. The formulation of claim 12 wherein the elastomer is at least one of: polypropylene based elastomer (PBE), ethylene-propylene copolymer (EPC), ethylene vinyl acetate (EVA), ethylene methyl acetate (EMA), ethylene butyl acetate (EBA), styrene-butadiene-styrene (SBS), styrene-isoprene-styrene (SIS), and styrene-ethylene-butadiene-styrene (SEBS).

14. The formulation of claim 12 wherein the polyethylene is at least one of high and low density polyethylene (HDPE, LDPE, LLDPE, m-LLDPE).

15. The formulation of claim 12, wherein the elastomer is an ethylene-propylene copolymer.

16. The formulation of claim 12, wherein the inorganic filler is at least one of: calcium carbonate, titanium dioxide, talc, and diatomite earth.

17. A planar film comprised of the formulation of claim 12, wherein the formulation includes about 50% polyethylene substrate, about 20% elastomer, and about 30% inorganic filler, and wherein said planar film is cast with thickness of about 0.018 mm and has a force at break of at least 2.5 N.
